(19) United States
(12) Patent Application Publication
(10) Pub. No.: US 2014/0173685 A1
(43) Pub. Date: Jun. 19, 2014

(54) CONTROLLING MODIFICATION OF ELECTRONIC DEVICE CABLING

(71) Applicant: INTERNATIONAL BUSINESS MACHINES CORPORATION, Armonk, NY (US)

(72) Inventors: William Bittles, Winchester (GB); Gordon J. Cockburn, Southampton (GB); Tim F. McCarthy, Eastleigh (GB); Jon Parkes, Portsmouth (GB); Steven G. White, Woking (GB)

(73) Assignee: INTERNATIONAL BUSINESS MACHINES CORPORATION, Armonk, NY (US)

(21) Appl. No.: 14/093,246

(22) Filed: Nov. 29, 2013

(30) Foreign Application Priority Data
Dec. 17, 2012 (GB) 1222706.2

(51) Int. Cl. G06F 21/70

(52) U.S. Cl. CPC G06F 21/70
USPC 726/1

(57) ABSTRACT

A cabling modification control unit controls modification of electronic device cabling with physical locks and includes a processing unit and a communication unit. The processing unit is configured to process a cable modification request and configured to generate a control signal based on the result of processing the cable modification request. The communication unit is configured to communicate the control signal to an electronic device component. The control signal is configured to control a physical lock associated with the electronic device component to permit or prevent modification of the electronic device cabling. The electronic device component includes a port configured to connect to the electronic device cabling and a physical lock that is configured to prevent connection or disconnection of the electronic device cabling to the port based on the control signal received from the modification control unit.

### FIELD

Embodiments of the present invention relate to electronic devices, such as a storage area network electronic device, and more particularly to controlling modification of electronic device cabling.

### DESCRIPTION OF THE RELATED ART

Storage area networks (SANs) are widely known for storing information or data. A SAN typically includes a number of storage devices, a plurality of Hosts, and a number of Switches arranged in a Switching Fabric that connects the storage devices and the Hosts.

Most SANs rely on the known Fibre Channel protocol for communication within the Fabric. A detailed explanation of the Fibre Channel protocol and Fibre Channel Switching Fabrics and Services can be found in the Fibre Channel Framing and Signaling Standard, Rev 1.70, American National Standard of Accredited Standards Committee (NCITS), Feb. 8, 2002, and the Fibre Channel Switch Fabric-2, Rev. 5.4, NCITS, Jun. 26, 2001, and the Fibre Channel Generic Services-3, Rev. 7.01, NCITS, Nov. 28, 2000. Detailed description of the Fibre Channel protocol and Fibre Channel Switching Fabrics and Services is therefore omitted.

In the Fibre Channel protocol, each device (hosts, storage devices and switches) is identified by a unique eight (8) byte wide identifier (Node_Name) assigned by the manufacturer. When the Fibre Channel devices are interconnected to form a SAN, the identifier (Node_Name), along with other parameters, is used to identify each device. Fibre Channel frames are used for communication among the devices in the SAN. The identifier (Node_Name), however, is not used by the frames. Instead, the Fibre Channel Port of each end device (hosts and storage devices) is addressed via a three (3) byte Fibre Channel address (or FC_ID), allocated dynamically to the end devices by the Fabric.

Adopters of the SAN storage model face the problem that accompanies every new technology and design: a scarcity of professionals experienced with the technology. The job of SAN administrator is often filled by persons with various skill sets and work backgrounds such as mainframe operators, traditional network administrators, system administrators, and other positions in the IT industry. Typical roles expected of a SAN administrator are securing the SAN and developing a data protection strategy, provisioning and administering SAN resources, testing new vendors' hardware and integrating it into the SAN, troubleshooting SAN elements, and managing day-to-day performance and SAN resource availability.

Keeping track of SAN devices and their connections in the SAN is a daunting task. It is common for new SAN devices to be added to the SAN and for existing SAN devices to be upgraded (e.g. firmware and driver upgrades). Today, many administrators manually track and provision their SAN using spreadsheets and inventory reports that are typically quickly outdated.

Maintenance of a SAN and its fabric is therefore typically a manual process that places an onus on the administrator to implement procedures to track changes to the SAN fabric and maintain appropriate records or documentation. If such records or documentation are outdated, incorrect decisions and/or connections within a SAN can be made.

### SUMMARY

According to an embodiment of the present invention, an electronic device cabling modification control unit that controls modification of electronic device cabling with physical locks includes a processing unit and a communication unit. The processing unit is configured to process a cable modification request and configured to generate a control signal based on the result of processing the cable modification request. The communication unit is configured to communicate the control signal to an electronic device component. The control signal is configured to control a physical lock associated with the electronic device component to permit or prevent modification of the electronic device cabling. In certain embodiments, the electronic device cabling is SAN fabric cabling and/or the electronic device component is SAN component.

In another embodiment, a method of controlling modification of electronic device cabling with physical locks, includes processing, with a cabling modification control unit, a cable modification request; generating, with the cabling modification control unit, a control signal based on the result of processing the cable modification request; transmitting, with the cabling modification control unit, the control signal to an electronic device component, and; based on the control signal, controlling a physical lock associated with the electronic device component so as to permit or prevent modification of the electronic device cabling.

In another embodiment, a computer program product for controlling modification of electronic device cabling with physical locks, the computer program product includes a computer readable storage medium having program code embodied therewith, the program code is executable to: process, with a cabling modification control unit, a cable modification request; generate, with the cabling modification control unit, a control signal based on the result of processing the cable modification request; transmit, with the cabling modification control unit, the control signal to an electronic device component, and; based on the control signal, control a physical lock associated with the electronic device component so as to permit or prevent modification of the electronic device cabling.

The embodiments are adapted to control access to electronic device cabling, such as SAN fabric cabling, through the use of physical locks. The physical locks may be software controlled mechanical locks, or any other suitable type of locks that are configurable between locked and unlocked configurations according to a control signal supplied in accordance with an embodiment of the invention. Embodiments may therefore employ electromechanical or electrostatic locks, for example.

There is accordingly proposed a concept for governance of electronic device cabling which may help to prevent cables being inserted or removed in error. Such governance may also restrict the modification of electronic device cabling to being part of an audited process, thus enabling changes in cabling to be automatically tracked and recorded.

Embodiments introduce a control unit which grants or denies permission to make changes to electronic device cabling. The decision whether or not to grant such permission may be made by taking into account authorization checks, error checks, electronic device cabling rules, predefined rules and/or best practices. If permission is granted, a message may be sent to a component of the electronic device which instructs the opening/unlocking of appropriate locks to enable removal of existing cables and/or insertion of new cables. Once the cabling changes have been implemented, or after a predetermined amount of time, the locks may be closed/locked and the cabling changes automatically recorded to maintain an audit trail. Embodiments may thus reduce or eliminate the need for manual tracking of electronic device components. In certain implementations, by masking administrative complexity of a SAN environment, embodiments may allow the potential of SANs to be realized.

### BRIEF DESCRIPTION OF THE DRAWINGS

Various embodiments of the present invention will now be described, by way of example only, with reference to the following drawings in which:

FIG. 1 depicts the topology of an electronic device cabling modification control system according to an embodiment;

FIG. 2 depicts a schematic block diagram of an electronic device cable modification control unit according to an embodiment;

FIG. 3 depicts a schematic block diagram of an electronic device component according to an embodiment of the invention;

FIG. 4 depicts a flow diagram of a method according to an embodiment of the invention; and

FIG. 5 depicts a schematic block diagram of computer system according to an embodiment of the invention.

### DETAILED DESCRIPTION

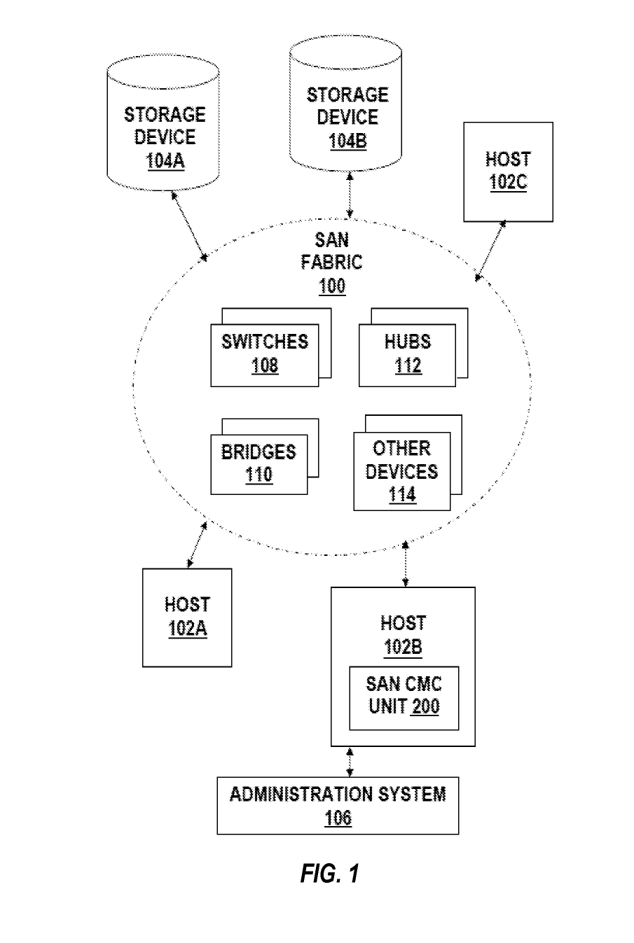

Referring to FIG. 1, there is shown an electronic device, such as a SAN fabric device, cabling modification control system according to an embodiment. A SAN may be a high-speed, special-purpose network that interconnects storage devices 104 (e.g. storage devices 104A and 104B) with associated data servers (e.g. hosts 102A, 102B, and 102C) on behalf of a larger network of users. This network may employ Fibre Channel technology.

The SAN may be part of the overall network of computing resources for an enterprise or other entity. The SAN may include a first host 102A, a second host 102B and a third host 102C, first storage device 104A and second storage device 104B, and a SAN fabric 100. The SAN may also include an administration system 106. One or more end-user platforms (not shown) may access the SAN, for example via a LAN or WAN connection to one or more of the hosts 102.

The storage devices may include any of one or more types of data storage devices including, but not limited to, storage systems such as RAID (Redundant Array of Independent Disks) systems, disk arrays, JBODs (Just a Bunch Of Disks, used to refer to disk cabinets that do not have a built-in RAID controller), tape devices, and optical storage devices. The hosts 102 may run any of a variety of operating systems.

The hardware components that connect hosts 102 (and other devices such as workstations) to storage devices 104 in the SAN is referred to as a fabric 100. The SAN fabric 100 enables server-to-storage device connectivity through Fibre Channel switching technology. The SAN fabric 100 hardware components may include one or more of switches 108 (also referred to as fabric switches), bridges 110, hubs 112, or other devices 114 such as routers, as well as the interconnecting cables (e.g. for Fibre Channel SANs, fibre optic cables). Thus the interconnecting cables are typically referred to as SAN fabric cables or SAN fabric cabling.

The fabric hardware 100 devices (i.e. the bridges 110, hubs 112, or other devices 114 such as routers) each comprise one or more ports that are adapted to connect to the SAN fabric cabling, so as to enable interconnections to be made between devices with SAN fabric cables. Each of the fabric hardware 100 devices also comprises a physical lock (not shown) adapted to prevent connection or disconnection of a SAN fabric cable to the port based on a received control signal received. Here, the locks are electromechanical locks that that are adapted to move between a locked and unlocked configuration in response to received electrical signal.

The second host 102B includes a SAN Cabling Modification Control (CMC) unit 200 which is adapted to generate and communicate such a control signal based on a request to modify the SAN fabric cabling.

The SAN CMC unit 200 is a client application provided by the second host 102B. The second host 102B provides a graphical user interface for displaying the information (e.g. XML data) compiled by and received from the SAN CMC unit 200 in graphical and/or textual format, and may provide a user interface for a SAN administrator to access various features of the SAN CMC unit 200 such as tools and utilities described herein to perform functions of the SAN CMC unit 200.

The SAN CMC unit 200 is adapted to grant or deny permission to make changes to SAN fabric cabling. A decision whether or not to grant such permission is made by the SAN CMC unit 200 by taking into account authorization checks, error checks, SAN fabric cabling rules, predefined rules and/or best practices.

If the SAN CMC unit 200 decides to grant permission to modify the SAN fabric cabling, the SAN CMC unit 200 generates a control signal and sends the control signal, as an extension to the Fibre Channel Protocol, to the electromechanical lock(s) of the appropriate SAN fabric device(s) so as to instruct the opening/unlocking of lock(s) and enable removal of existing cables and/or insertion of new cables. Once the cabling changes have been implemented, the user/administrator can inform the SAN CMC unit 200, and the SAN CMC unit 200 then generates and sends a new control signal instructing the closure/locking of the lock(s) to prevent removal of the cables and/or insertion of new cables.

In this embodiment, the SAN CMC unit 200 is also adapted to store information about the request to make changes to SAN fabric cabling. By way of example, such information may relate to at least one of: a source of the request; a user associated with the request; one or more SAN cabling ports associated with the request; the time of the request; and the date of the request. In this regard, a user may submit a request to have a particular port either activated, changed, etc. Here, a user with privileged authority (e.g. Super User or Systems Administrator) can authorize and actually action a submitted request. Information relating to such a change Control Request may include: user info; actual details of the request; date and time; business need for the change; who if any is affected; who needs to review this change; any other interested parties involved; who will execute the action, etc.; authorized by; scheduled date and time of action; when and if the action was executed successfully; or associated comments. In this way, the SAN CMC unit 200 can record information about SAN fabric cabling changes that are requested and/or made so as to maintain an audit trail for the SAN.

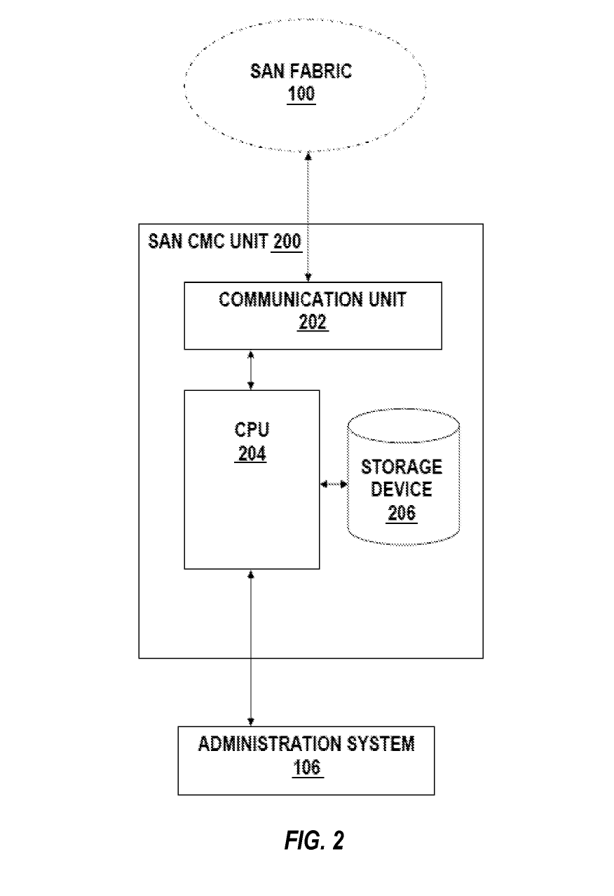

Referring now to FIG. 2, there is illustrated a schematic block diagram of an electronic device cable modification control, such as the SAN SMC Unit 200. The SAN SMC Unit 200 is adapted to generate a control signal which can be used to control a physical lock associated with a SAN component so as to permit or prevent modification of SAN fabric cabling. The SAN SMC Unit 200 comprises a communication unit 202, a central processing unit (CPU) 204 and a storage device 206. The CPU is adapted to process receive and process a cable modification request provided to it from the administration system 106 of the SAN network. Based on the result of processing the cable modification request, the CPU 204 is adapted to generate a control signal for controlling one or more physical locks associated with one or more SAN components.

CPU 204 processes a cable modification request in conjunction with predefined rules defining access rights to ports of SAN components, wherein the predefined rules are stored by the storage device 206. Thus, in order process a cable modification request, the CPU 204 retrieves stored information regarding access rights from the storage device. Based on the retrieved information, and the cable modification request, the CPU 204 analyses the cable modification request and makes a determination as to whether or not a requested cable modification is allowable and/or correct. If the CPU 204 determines the requested cable modification is allowable and/or correct, the CPU 204 generates a control signal and passes the generated control signal to the communication unit 202 (which transmits the control signal to one or more SAN components). To aid such communication, and ensure that the control signal is transmitted to the appropriate SAN component(s), the generated control signal may comprise information identifying one or more recipient components.

It will therefore be understood that the SAN CMC unit 200 grants or denies permission to make changes to SAN fabric cabling. The decision whether or not to grant such permission can take into account various authorization checks, error checks, SAN fabric cabling rules, predefined rules and/or best practices. Permitted cabling changes can also be automatically recorded to maintain an audit trail by storing information about the changes in the storage device 206.

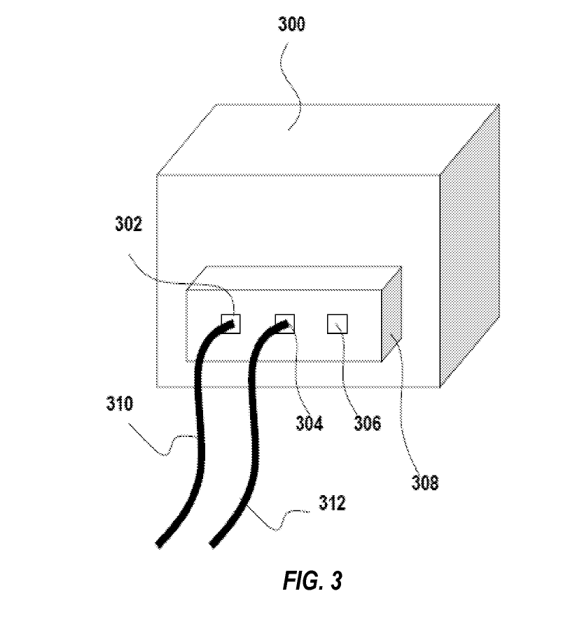

Referring now to FIG. 3, there is illustrated a schematic block diagram of an electronic device component, such as a SAN fabric hardware component, or SAN device, according to an embodiment. Here the electronic device component may be a switch 300 and may include a first port 302, second port 304, and third port 306 ports for connecting to SAN fabric cables; and a physical lock 308 adapted to prevent connection or disconnection of SAN fabric cables to the ports 302, 304, 306. In the illustrated embodiment, a first SAN fabric cable 310 is connected to the first port 302, and a second SAN fabric cable 312 is connected to the second port 304. Thus, the third port 306 is does not have a SAN fabric cable connected to it.

In this embodiment, the physical lock 308 comprises an electrostatic lock which is adapted to be transferable between locked and unlocked configurations based on a control signal received from a SAN CMC unit according to an embodiment of the invention. Although an electrostatic lock has been described in this embodiment, it will be appreciated that other types of locks may be suitable. By way of example, another type of lock that may be used could be a mechanical/electrical lock where the physical lock is locked or unlocked via physical rotation of a plug e.g. 90°, after a pin is electrically removed.

In the locked configuration, the lock 308 prevents connection or disconnection of a SAN fabric cable from any of the first port 302, second port 304, or third 306 port. Conversely, in the unlocked configuration, the lock 308 permits connection or disconnection of a SAN fabric cable from any of the first port 302, second port 304, or third 306 port.

The switch 300 therefore provides a system by which can prevent SAN fabric cables being inserted or removed in error. Providing such control over cable modification in response to received control signal can restrict the modification of SAN fabric cabling to being part of an audited process.

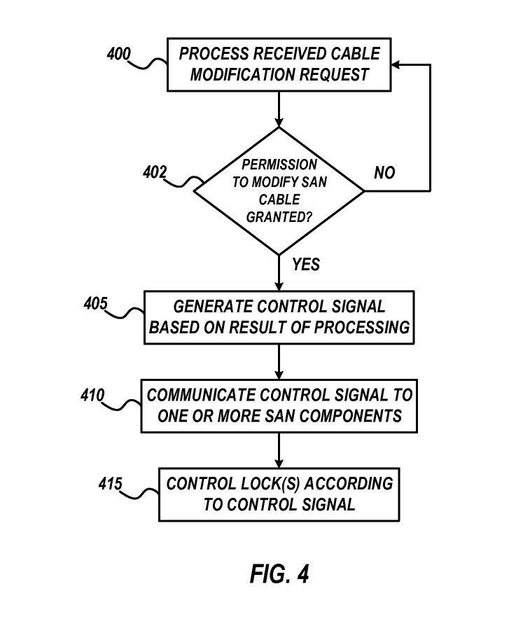

Turning now to FIG. 4, there is depicted a flow diagram of a method of controlling modification of electronic device cabling, such as SAN fabric cabling, according to an embodiment of the invention. The method begins at block 400 in which a received cable modification request (e.g. provided via a user interface, etc.) is processed. The block 400 of processing the request comprises an analysis of the content of the request in accordance with predefined rules which define access rights to SAN cabling ports.

Based on the result of the processing block 400, the method decides, in block 402, whether or not permission to modify the SAN fabric cable is granted. If permission is not granted, the method returns to block 400 in which another/subsequently received cable modification request is processed. If permission to modify the SAN fabric cabling is granted, the method continues to block 405.

At block 405, a control signal is generated in accordance with the result of processing. The generated control is adapted to control a physical lock associated with one or more SAN components so as to permit or prevent modification of SAN fabric cabling.

At block 410, the generated control signal is communicated to the one or more SAN components. Such communication may be achieved by transmitting the control signal using a conventional protocol or via a proprietary protocol specially developed for transmission of such control signals. In this embodiment, the SAN is a Fibre Channel SAN comprising fibre optic cables for the SAN fabric cabling, and so the control signal is transmitted as an extension of the known Fibre Channel Protocol. In this regard, it will be appreciated that, in some embodiment, a control signal may be broadcast across the entire SAN network and only acted upon by the component(s) identified as a recipient by the control signal. In other embodiments, the control signal may only be sent to one or more specifically targeted components, and so not comprises information identifying the intended recipient (since a recipient component may assume that it was intended to receive the control message).

At block 415, an electromechanical lock associated with each of the one or more SAN components is controlled based on the control signal so as to permit or prevent modification of SAN fabric cabling. By way of example, a lock can be controlled to change from a locked configuration (which prevents cabling changes to a port of the SAN component) to an unlocked configuration (which allows cabling changes to the port of the SAN component).

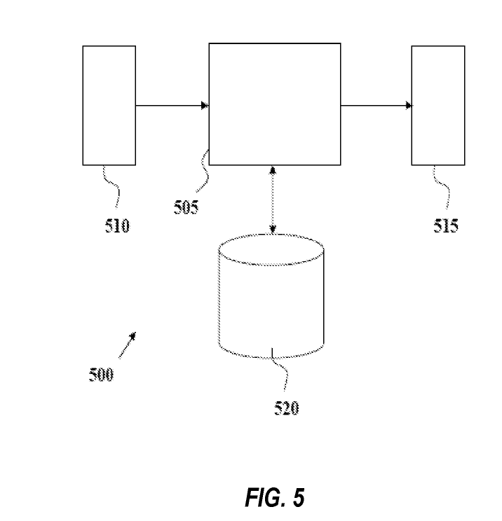

Referring now to FIG. 5, there is illustrated a schematic block diagram of a computer system 500 according to an embodiment. The computer system 500 is adapted to control modification of electronic device cabling, such as SAN fabric cabling, by generating and transmitting control signals which are adapted to control the configuration of a physical lock associated with an electronic device component, such as a SAN device. The system comprises a processing unit 505 having input 510 and output 515 interfaces, and a data storage unit 520 connected to the processing unit 505.

The input interface 510 is adapted to receive inputs and/or instructions from user, and the output interface 515 is adapted to provide a control signal from the processing unit 505 to a SAN component. The output interface 515 is also adapted to provide information about the control signal (such as information identifying one or more SAN component ports that are locked or unlocked by the control signal) to the user.

The data storage unit 520 is adapted to store one or more machine readable descriptions of rules and/or port access rights associated with the SAN. In other words, the data storage unit 520 is adapted to data the can be used by the processor to analyze or process an input received from the input interface 510.

The processing unit 505 is adapted to execute a computer program which, when executed, causes the system to implement the steps of a method according to an embodiment, for example the method as shown in FIG. 4.

The processing unit 505 is adapted to receive, via the input interface 510, a request to modify SAN fabric cabling. Based on this request and information stored in the data storage unit 520, the processing unit 505 analyses the request to determine what SAN fabric cabling may be affected by the request and whether or not the requested modification is allowable. More specifically, the processor analyses the request supplied by the user in conjunction with the stored data to determine which SAN component ports should be unlocked to allowable modification of their connection(s). The processor 505 the generates a control signal for the identified SAN component ports and provides the control signal to the SAN components via the output interface 515. Thus, the processor 505 is adapted to control the configuration of physical locks associated with SAN component ports so as to enable or disable modification of SAN fabric cabling connections to the ports.

It will be understood that the proposed embodiments implement a method for controlling modification of SAN fabric cabling using controllable locks. The locks may be adapted to enable or prevent modification to port connections to the SAN fabric cabling in accordance with control signals that are provided from a control unit or control application. Incorrect SAN fabric cabling connection may therefore be prevented and/or a user can be restricted to only making specific fabric cabling connections. A user may therefore not need to have a detailed understanding of a SAN in order to implement correct cabling decisions.

Embodiments may be captured in a computer program product for execution on the processor of a computer, e.g. a personal computer or a network server, where the computer program product, if executed on the computer, causes the computer to implement the processes of a method according to an embodiment, e.g. the method as shown in FIG. 4. Since implementation of these processes into a computer program product requires routine skill only for a skilled person, such an implementation will not be discussed in further detail for reasons of brevity only.

In an embodiment, the computer program product is stored on a computer-readable medium. Any suitable computer-readable medium, e.g. a CD-ROM, DVD, USB stick, memory card, network-area storage device, internet-accessible data repository, and so on, may be considered.

Various modifications will be apparent to those skilled in the art. For example, an embodiment may run on any of a variety of end-user platforms coupled to one or more of the hosts 102, for example via a LAN or WAN, or alternatively may run on one of the hosts 102, including the host 102B that includes the SAN CMC unit 200.

In one embodiment, there may be provided a graphical user interface (GUI) through which the cabling modification control facilities can be facilitated by allowing a user to graphically view the logical and physical devices on the SAN. One embodiment may provide the ability to zoom in or out on areas of interest in a SAN topology map to simplify the navigation of the SAN and identify desired/requested cabling changes. Within the topology map, integrated tool tips may be provided to help identify devices and paths in the SAN without having to navigate through a complex topology.

Embodiments may run on all SAN-attached hosts 102. However, in some embodiments some hosts may not implement a SAN cabling modification control unit.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGs. illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

The invention claimed is:

1. An electronic device cabling modification control unit that controls modification of electronic device cabling with physical locks, comprising:
a processing unit configured to process a cable modification request and configured to generate a control signal based on the result of processing the cable modification request; and
a communication unit configured to communicate the control signal to an electronic device component, wherein the control signal is configured to control a physical lock associated with the electronic device component to permit or prevent modification of the electronic device cabling.

2. The control unit of claim 1, wherein the processing unit is configured to process a cable modification request in accordance with one or more rules defining access rights to one or more cabling ports.

3. The control unit of claim 2, wherein the processing unit is further configured to store information regarding the result of processing the cable modification request.

4. The control unit of claim 3, wherein the information comprises:
data relating to a source of the request;
data relating to a user associated with the request;
data relating to the one or more cabling ports associated with the request;
data relating to the time of the request, and:
data relating to the date of the request.

5. The control unit of claim 4, wherein the communication unit is configured to send the control signal using Fibre Channel Protocol.

6. The control unit of claim 1 wherein the electronic device component comprises:
one or more ports configured to connect to the electronic device cabling, and;
a physical lock configured to prevent connection or disconnection of the electronic device cabling to a port based on the control signal received from an electronic device cabling modification control unit.

7. The control unit of claim 6, wherein the physical lock is locked or unlocked according to the control signal.

8. The control unit of claim 1 wherein the electronic device cabling is storage area network (SAN) fabric cabling.

9. The control unit of claim 1 wherein the electronic device component is a storage area network (SAN) component.

10. A method of controlling modification of electronic device cabling with physical locks, the method comprising:
processing, with a cabling modification control unit, a cable modification request;
generating, with the cabling modification control unit, a control signal based on the result of processing the cable modification request;
transmitting, with the cabling modification control unit, the control signal to an electronic device component, and;
based on the control signal, controlling a physical lock associated with the electronic device component so as to permit or prevent modification of the electronic device cabling.

11. The method of claim 10, wherein processing the cable modification request further comprises:
processing the cable modification request in accordance with one or more rules defining access rights to one or more cabling ports.

12. The method of claim 11, further comprising:
storing, with the cabling modification control unit, information regarding the result of processing the cable modification request.

13. The method of claim 12, wherein the information comprises:
data relating to a source of the request;
data relating to a user associated with the request;
data relating to one or more cabling ports associated with the request;
data relating to the time of the request, and;
data relating to the date of the request.

14. The method of claim 10 wherein the electronic device cabling is storage area network (SAN) fabric cabling.

15. The method of claim 10 wherein the electronic device component is a storage area network (SAN) component.

16. A computer program product for controlling modification of electronic device cabling with physical locks, the computer program product comprising a computer readable storage medium having program code embodied therewith, the program code executable to:
process, with a cabling modification control unit, a cable modification request;
generate, with the cabling modification control unit, a control signal based on the result of processing the cable modification request;
transmit, with the cabling modification control unit, the control signal to an electronic device component, and;
based on the control signal, control a physical lock associated with the electronic device component so as to permit or prevent modification of the electronic device cabling.

17. The computer program product of claim 16, wherein the program code executable to process the cable modification request is further executable to:
process the cable modification request in accordance with one or more rules defining access rights to one or more cabling ports.

18. The computer program product of claim 16, wherein the program code is further executable to:
store, with the cabling modification control unit, information regarding the result of processing the cable modification request.

19. The computer program product of claim 18, wherein the information comprises:
data relating to a source of the request;
data relating to a user associated with the request;
data relating to one or more cabling ports associated with the request;
data relating to the time of the request, and;
data relating to the date of the request.

20. The computer program product of claim 16 wherein the electronic device cabling is storage area network (SAN) fabric cabling and wherein the electronic device component is a SAN component.
